(19) United States
(12) Patent Application Publication
(10) Pub. No.: US 2009/0189862 A1
(43) Pub. Date: Jul. 30, 2009

(54) METHOD, COMPUTER PROGRAM PRODUCT AND DEVICE FOR TEXT EDITING

(76) Inventor: Daniel VIBERG, Lidingo (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 12/019,000

(22) Filed: Jan. 24, 2008

(51) Int. Cl. G06F 3/02; G06F 17/24

(52) U.S. Cl. 345/168; 715/272; 715/271

(57) ABSTRACT

The invention relates to a method for enabling a user to edit a text on a screen comprising the steps of: defining the text into at least one block, enabling the at least one block to be selected by the user, associating at least one function with the at least one block, and presenting the at least one block selected by a user and its associated function to the user on the screen upon selection of the at least one block.

### FIELD OF THE INVENTION

The invention relates to a method for editing text. In particular, the invention relates to a method for editing text when using an electronic device.

### BACKGROUND OF THE INVENTION

A common feature in electronic devices of today is to provide a user of the device a possibility of inputting a text matter in an application, such as, writing a document, a message, a mail or the like. A number of different configurations of data input interfaces exist, such as touch panels, keypads and the like, to enable a user to input the text. In such devices text editing is often made complicated by the need to access various sub menus or not possible at all.

Hence, when writing/editing text messages it may be difficult to edit, delete and move words. On portable devices this is in part due to the small size of the screen and the small text on the device that makes it hard to select specific areas. Another factor that makes editing of text on portable devices more difficult than on a computer is the need to go into sub menus to, for example, “cut and paste” text whereas on a computer short cut-symbols in a menu head may be used. When using a computer one may use keyboard commands, shorts cuts or sub menus after one has marked the word. Marking a word may be done by either double clicking a word or by holding down a mouse button and dragging the cursor over the word. Editing words with keyboard commands may be done by pressing down the keys such as Ctrl-c to copy a word after one has marked the word. Editing words by selecting a short cut may be done by clicking on a second mouse button displaying a menu of selectable alternatives. Sub menus for marked words may also be reached as drop down menus from a preset menu head.

However, there is a need to process text in a text processing application in a more facilitated manner.

### SUMMARY OF THE INVENTION

Some embodiments of the invention address the need to facilitate the text processing performed by a user.

The invention relates a method for enabling a user to edit a text on a screen comprising the steps of: defining the text into at least one block, enabling the at least one block to be selected by the user, associating at least one function with the at least one block, and presenting the at least one block selected by a user and its associated function to the user on the screen upon selection of the at least one block.

In an embodiment the selected block and/or the associated function are visualized such that the selected block and/or the associated function are emphasized from the rest of the text.

In addition, the associated function may be visualized in the vicinity of the selected block.

Furthermore, the step of presenting the selected block may further comprise the step of visualizing the block as a three dimensional structure comprising at least an upper area and a main area, wherein content of the defined block is displayed in the main area.

In an embodiment the three dimensional structure comprises a side area connected to the upper area and the main area, forming a structure that visually protrudes from the rest of the amount of text.

In addition, each area may comprise at least one selectable editing function of the content of the selected block.

Furthermore, the function may comprise displaying a correct spelled word or a synonym to the content in the block displayed.

In an embodiment, the corrected word or synonym is displayed on and/or in the vicinity of the block and arranged to spin into focus, placing the corrected word or synonym as the content in the block.

The content of the block is in an embodiment either input characters, space characters or a combination of both.

The invention further relates to an electronic device comprising, a memory unit comprising a text processing application arranged to enable a user to input/edit characters, and a block text application arranged to form at least one block from characters of the text processing application, wherein the at least one block is arranged to be selectable by a user of the electronic device, and to associate at least one function with the at least one block, wherein the block text application is further arranged to provide display data for a selected block that has been selected by the user and its associated function, a control unit arranged to execute the text processing application and the block text application stored on the memory unit, and a data interface arranged to display the display data of the selected block and the function associated with the selected block.

In addition, the block application may be arranged to display the selected block such that the block is emphasized from the rest of the input characters.

Furthermore, the selected block may be displayed as a three dimensional structure comprising a number of defined areas, wherein at least one area is arranged to present the associated function.

An embodiment discloses an electronic device wherein each area of the displayed block is arranged to present at least one editing function.

The electronic device may comprise means for performing a marking operation and the block text application may be arranged to detect that a block has been selected when the user has performed a marking operation direct on or in the vicinity of the block.

Additionally, the data interface may be an output interface arranged to display data and an input interface arranged to input data.

The input interface of the electronic device may comprise a keypad.

The data interface of the electronic device may comprise a touch screen.

The electronic device may be a portable device, such as a mobile phone.

The invention relates to a computer program product carrying a computer program embodied in a computer readable medium adapted to perform, when being run on a control unit, the steps of defining characters into at least one block, enabling the at least one block to be selected by the user, associating at least one function to the at least one block, and presenting the at least one block and its associated function when the at least one block is selected by the user.

In an embodiment, the step of presenting a selected block may further comprise the step of visualizing the selected block as a three dimensional structure comprising at least an upper area and a main area, wherein the input characters of the defined block is displayed in the main area.

In addition, the step of presenting a selected block may further comprise the step of visualizing the selected block by emphasizing, such as underlining, enlarging, or the like, the content of the selected block and/or the at least one associated function.

Text editing is made much smoother if each word and empty space is treated as a solid object. Pressing on or in close proximity of a word should, in an embodiment, make it pop out of the body of text in some sort of solid shape that could be anything like a triangle, rectangle, etc. This shape will be “drag and drop”-able to facilitate the operation of moving around words and the corners and faces of the solid block will act as quick links to commands such as delete, copy, paste, etc.

### BRIEF DESCRIPTION OF THE DRAWINGS

The invention, together with further objectives and advantages thereof, may best be understood by reference to the following description taken in conjunction with the accompanying drawings in which:

FIG. 1 shows a schematic overview of a portable device,

FIG. 2 shows a schematic overview of a screen using a text editing function of an embodiment of the invention,

FIG. 3 shows a schematic overview of an embodiment of the invention, and

FIG. 4 discloses a schematic flow chart of a method of editing text according to an embodiment of the invention.

### DETAILED DESCRIPTION OF EMBODIMENTS OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that several blocks of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein as employed in and with a wireless communications device, also denoted a portable device. In the context of the invention, the portable device may e.g. be a mobile phone, a PDA (Personal Digital Assistant) or any other type of portable computer such as laptop computer, however, it should be understood that the invention may as well be implemented in any type of an electronic device comprising a text processing program such as a stationary computer or the like.

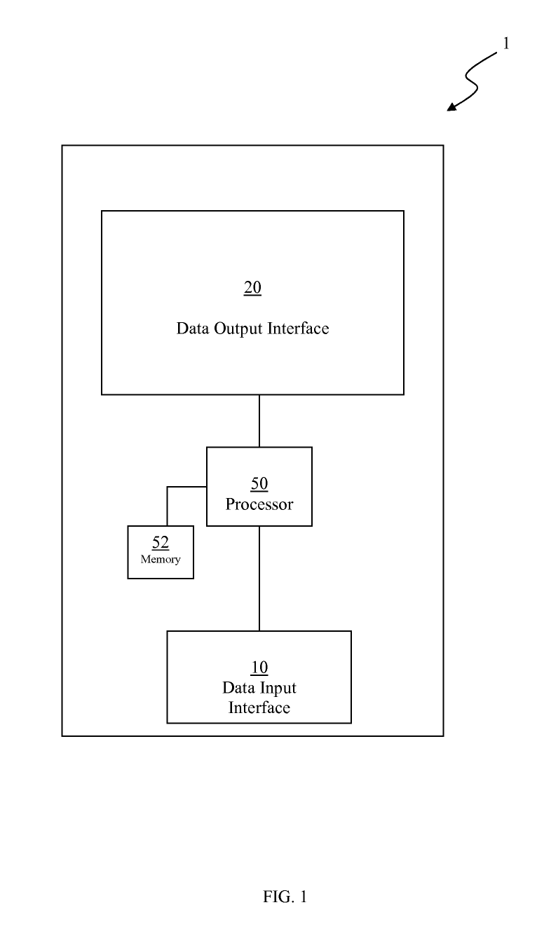

FIG. 1 discloses a schematic overview of an embodiment of a portable device 1. The device comprises a control unit 50 such as a central processing unit, field-programmable gate array, micro processor or the like. The portable device 1 comprises a memory 52 containing applications/programs that are executed on control unit 50. The portable device 1 further comprises a data output interface 20, such as a display, and a data input interface 10 such as keys or the like. It should here be noted that in the illustrated examples a touch screen portable device will be illustrated making the data output interface into a combined data input/output interface; a data interface.

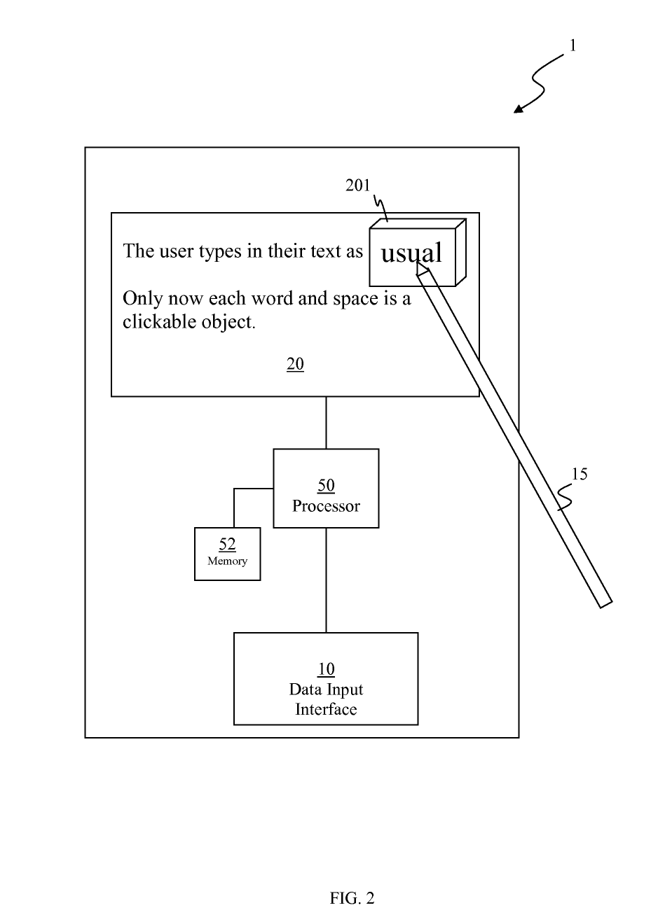

In an embodiment the invention relates to a method for editing text. In FIG. 2 an embodiment of the invention is disclosed. In the shown embodiment each written word is automatically made into a solid block. The solid block is a clickable solid object 201, as shown in FIG. 2. The illustrated block 201 is defined by the inputted space and each space block is defined as a block being between two entered textual letters by a program running on the processor 50. As a user clicks on a word (selects the word), in the example “usual”, the block is activated and the word appears as a block 201.

The characters used when typing a message or an amount of text may be divided into two different types; a first type denoted input characters, which are letters, symbols and the like, and a second type denoted space characters, which are punctuations, spaces, line changes and the like. The differentiation may be made by the Unicode of the different characters, stating that certain unicodes are input characters and certain unicodes are space characters. A block may further contain a space before or after the defined word.

In an embodiment the text in the block 201 is magnified making it easier to read and facilitating the editing of the selected word. The marker may still be placed wherever the user has pressed on the word so that the operation of adding or removing a letter is easily performed. By providing the function of making the text word into a solid block the selection of a word is facilitated since you may press anywhere in the vicinity of the word to activate the block. If the portable device 1 comprises a touch screen enabling a drag and drop function the object may be drag and droppable using a pointing device 15, such as a stylus pen, finger or the like.

To further facilitate editing pressing on different parts of the solid block would initiate a function associated with the word, which parts could be linked to various quick commands. Some examples of this feature are described below. In an embodiment the user may predefine different functions relating to different parts of the object.

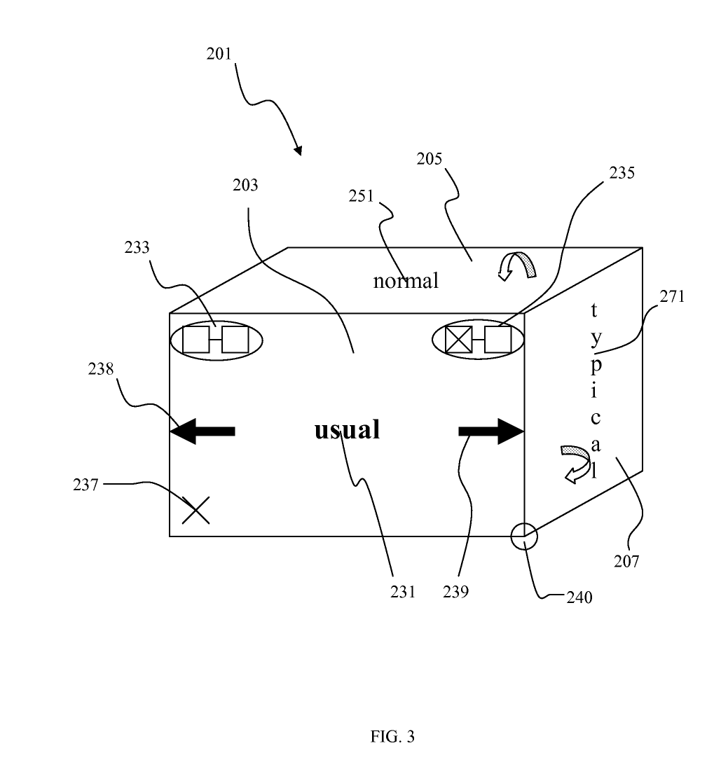

In an embodiment the block is presented as a three dimensional block. FIG. 3 shows an embodiment of a three dimensional block 201. The block 201 comprises a first visual area 203 containing the selected word/space 231. The word 231 may be underlined, put in a different font, made bold, cursive, magnified and/or the like. As the block is activated the word is editable and, for example, letters may be added or deleted to the word. The first visual area 203 may further comprise a number of touchable functions. In the top left corner a copy area 233 presenting a copy function is illustrated, when touched the solid block is copied and put in a copy cache, and in the top right corner a replace area 235 is shown that, when touched, replaces the selected block 201 with a solid block from the memory cache that previously has been deleted/cut or copied. In addition, the first visual area 203 comprises a delete/cut area 237 in order to delete/cut the block 201 from the text, a right arrow 238 to move selection/activation of a block to the right of the block 201, a left arrow 239 to move the selection/activation of a block to the left of the block 201, and a resizing area 240 being the corner of the visual area to resize/change size of the block 201.

In the illustrated embodiment the block 201 further comprises a second visual area 205 that may comprise a synonym 251 of the word of the first visual area, or other suggestions, such as a word spelled correct or the like. When this area is pressed/touched the block 201 visually spins vertically and replaces the word 231 with the synonym 251.

Furthermore, the block 201 comprises a third visual area 207 with, for example, a second synonym 271 of the word and when this is pressed the block spins in a lateral manner as opposed to the spin of the second visual area 205 that spins vertically.

In this way may the user easily selects the word “usual” for editing by pressing on any of the letters of the word 231. When the word is pressed by a user the three dimensional block appears on the screen. The user may then edit the word using the different functions. The user may also merely drag and drop the block in the text.

It should be understood that any block design may be used. Examples may be; an enlarged two dimensional square comprising short cut symbols in the square or in the vicinity of the square, a three dimensional ball with functions on its sides, a cut diamond shaped block with functions visualized on sides of the diamond etc.

It should be noted that any editing textual function or the like may be used in the block as well as short cuts such as an Internet search button.

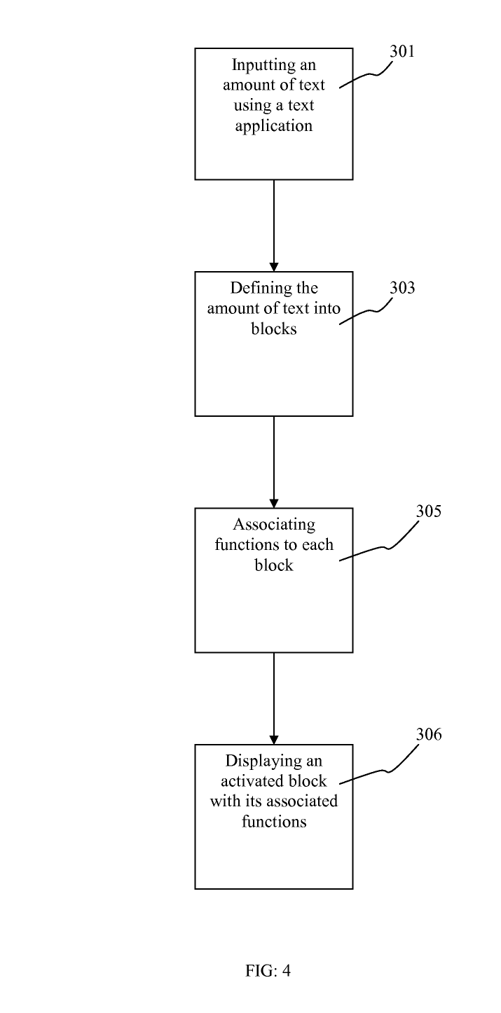

FIG. 4 shows a schematic flow chart of a method for editing text when using a word processing program, a text messaging program or the like on a portable device.

In step 301, a user inputs an amount of text while using a text application, such as SMS-messaging, mail, word or the like.

In step 303, the block application defines the amount of text into blocks and enables the blocks to be selected by a user.

In step 305, each block is associated with a function, such as copy, paste, internet search button, or the like.

In step 306, the user presses a word and thereby the block is activated and is visually displayed with its associated functions displayed in the vicinity of the activated block. The word may then be edited, copied, changed, moved, and/or the like. It should be noted that the word may be activated in a different way when using a keypad.

In order to clarify the facilitated use when operating with the block application an example is herein described. The user of a wireless phone is writing an SMS using a touch screen. When the user has written two sentences the third word in the first sentence is considered to be erroneously placed. The user presses the word using a stylus pen and the word is blown up in a three dimensional brick design protruding from the rest of the text, the user then presses the symbol illustrating the cut function cutting out the block from the amount of text. The user selects an appropriate position for the cut word and selects a word, symbol or space block. The block is blown up displaying a number of associated functions. The user then selects the paste symbol wherein the cut word block replaces the selected block and, if necessary, new spaces are created before and/or after the block. If the replaced word started with a capital letter, then the first letter of the pasted word may automatically be changed to a capital letter.

Conclusively, the operation of moving a word is facilitated into a four-touch operation.

The block function may comprise short cuts, smart functions, synonyms, spell correction and/or the like. The block program is running simultaneously and in addition to the text messaging program or the like, and divides the amount of text into blocks, wherein each block is, for example, defined as a letter/symbol between two spaces or spaces between letters or the like. The block may also comprise a word and a space, wherein the block is defined as a first letter and a space. The program visualizes the block in a manner to facilitate the processing of the word. The program transmits display data of the block and its associated functions to a display.

The block function may be activated when the word is touched by, for example, a stylus pen once, or when double clicked in order to enable the textual editing of inserting/deleting a letter in the word without activating the block. The blocks could also be activated by holding the selector key pressed in for a certain amount of time. In a computer environment the block could be activated by holding a mouse button pressed in over the word and the shortcuts activated by dragging the cursor over the shortcut and letting go of the button. In this way the normal way of text editing remains intact and the block system is optional. Other ways of activating a block may be by selecting the word using a keystroke or the like.

It should be understood that the block may be presented as a two dimensional square surrounding the selected block, a line underlining the selected block or any change in font, colour, size or the like. The editing functions may be presented as flags, bubbles, or just as symbols/text surrounding the selected word. The functions may be arranged in the vicinity of the block, connected to, adjacently placed, joined to, or on the block, such that the operation of selecting the functions is facilitated.

The block and the editing functions may be displayed in the display area of the portable device simultaneously or with a delay between the block and the functions. The point is that the selected block and its functions are displayed without any further interaction from the user. That is, the functions will automatically be displayed when a word is selected.

Portable communication devices, such as mobile phones, PDA and so on, have a small display with, for example, 320 times 320 pixels. As the area of the display is rather small resulting in a rather small pointer/text and that a user does not use a mouse to control the pointer on the display, the editing of text is hard and an embodiment, wherein the selected text is magnified and enhanced as well as displayed with editing options, facilitates the editing of the word.

The foregoing has described the principles, preferred embodiments and modes of operation of the present invention. However, the invention should be regarded as illustrative rather than restrictive, and not as being limited to the particular embodiments discussed above. It should therefore be appreciated that variations may be made in those embodiments by those skilled in the art without departing from the scope of the present invention as defined by the following claims.

1. A method for enabling a user to edit a text on a screen comprising the steps of:
defining the text into at least one block,
enabling the at least one block to be selected by the user,
associating at least one function with the at least one block, and
presenting the at least one block selected by a user and its associated function to the user on the screen upon selection of the at least one block.

2. A method according to claim 1, wherein the selected block and/or the associated function are visualized such that the selected block and/or the associated function are emphasized from the rest of the text.

3. A method according to claim 1, wherein the associated function is visualized in the vicinity of the selected block.

4. A method according to claim 1, wherein the step of presenting the selected block further comprises the step of visualizing the block as a three dimensional structure comprising at least an upper area and a main area, wherein content of the defined block is displayed in the main area.

5. A method according to claim 4, wherein the three dimensional structure further comprises a side area connected to the upper area and the main area, forming a structure that visually protrudes from the rest of the amount of text.

6. A method according to claim 5, wherein each area comprises at least one selectable editing function of the content of the selected block.

7. A method according to claim 1, wherein the function comprises displaying a correct spelled word or a synonym to the content in the block displayed.

8. A method according to claim 7, wherein the corrected word or synonym is displayed on and/or in the vicinity of the block and arranged to spin into focus, placing the corrected word or synonym as the content in the block.

9. A method according to claim 1, wherein the content of the block is either input characters, space characters or a combination of both.

10. An electronic device comprising,
a memory unit comprising a text processing application arranged to enable a user to input/edit characters, and a block text application arranged to form at least one block from characters of the text processing application, wherein the at least one block is arranged to be selectable by a user of the electronic device, and to associate at least one function with the at least one block, wherein the block text application is further arranged to provide display data for a selected block that has been selected by the user and its associated function,
a control unit arranged to execute the text processing application and the block text application stored on the memory unit, and
a data interface arranged to display the display data of the selected block and the function associated with the selected block.

11. An electronic device according to claim 10, wherein the block application is arranged to display the selected block such that the block is emphasized from the rest of the input characters.

12. An electronic device according to claim 10, wherein the selected block is displayed as a three dimensional structure comprising a number of defined areas, wherein at least one area is arranged to present the associated function.

13. An electronic device according to claim 12, wherein each area is arranged to present at least one editing function.

14. An electronic device according to claim 10, wherein the electronic device comprises means for performing a marking operation and the block text application is arranged to detect that a block has been selected when the user has performed a marking operation direct on or in the vicinity of the block.

15. An electronic device according to claim 10, wherein the data interface is an output interface arranged to display data and an input interface arranged to input data.

16. An electronic device according to claim 15, wherein the input interface comprises a keypad.

17. An electronic device according to claim 10, wherein the data interface comprises a touch screen.

18. An electronic device according to claim 10, wherein the electronic device is a portable device.

19. A computer program product carrying a computer program embodied in a computer readable medium adapted to perform, when being run on a control unit, the steps of
defining characters into at least one block,
enabling the at least one block to be selected by the user,
associating at least one function to the at least one block, and
presenting the at least one block and its associated function when the at least one block is selected by the user.

20. A computer program product according to claim 19, wherein the step of presenting a selected block further comprises the step of visualizing the selected block as a three dimensional structure comprising at least an upper area and a main area, wherein the input characters of the defined block is displayed in the main area.

21. A computer program product according to claim 19, wherein the step of presenting a selected block further comprises the step of visualizing the selected block by emphasizing, such as underlining, enlarging, or the like, the content of the selected block and/or the at least one associated function.
